(19) United States
(12) Patent Application Publication
(10) Pub. No.: US 2014/0172238 A1
(43) Pub. Date: Jun. 19, 2014

(54) Motor Vehicle Driver and Passenger Identification System and Method

(71) Applicant: Dean A. Craine, Bonney Lake, WA (US)

(72) Inventor: Dean A. Craine, Bonney Lake, WA (US)

(21) Appl. No.: 14/108,034

(22) Filed: Dec. 16, 2013

Related U.S. Application Data
(60) Provisional application No. 61/737,758, filed on Dec. 15, 2012.

(51) Int. Cl. B60W 50/00; B60W 10/30

(52) U.S. Cl. CPC B60W 50/0098; B60W 10/30
USPC 701/48

(57) ABSTRACT

A system and method for automatically determining the identify of a previously identified driver and then automatically adjusting a vehicle's entertainment settings, the seating settings, the mirror settings, and the climate control settings desired by the driver. The system may also select and transmit customized welcome and personal voice commands to the driver while the vehicle is operated. The system includes a first Bluetooth transceiver located inside a motor vehicle configured to create a piconet with a compatible second Bluetooth receiver in an electronic device associated to the driver and transported to the motor vehicle. The first Bluetooth transceiver is coupled to a motor vehicle based control unit with a control program. The control unit is coupled to a user database, a setting database, and a voice software program. When the electronic device in the vicinity of the motor vehicle and a piconet is created, the identity of the driver is determined and the control unit adjusts and vehicle's the settings and the play back voice accordingly.

This utility patent application is based on and claims the priority filing date benefit of U.S. provisional patent application (Application No. 61737758) filed on Dec. 15, 2012.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to systems and methods used to personalize and control the operational and entertainment settings in a motor vehicle to the driver and passengers that occupy the motor vehicle.

2. Description of the Related Art

In most marriages, each spouse is assigned to one motor vehicle which he or she drives to work or to run errands. Occasionally, the spouses will exchange motor vehicles or commute together in one of the motor vehicle. The entertainment system settings, the seat position settings, mirrors position settings, and the climate control settings are normally preset by the spouse assigned to the motor vehicle. When spouse unassigned to the motor vehicle drives the motor vehicle assigned to the other spouse, the spouse unassigned to the motor vehicle often make changes and not return them to their original positions after driving the motor vehicle.

Most spouses control and maintain a key for the motor vehicle they drive regularly. Many motor vehicles use an electronic access and authorization system, called a ‘smart key’ typically built into a key fob that can be kept in their pocket or purse when unlocking, locking and starting the vehicle.

Today, most motor vehicles also have Bluetooth transmitters and receivers (called Bluetooth transceivers) located inside the passenger compartments that can be linked to the Bluetooth transceivers in cellular telephones and other devices commonly carried by a driver or passenger of a motor vehicle. Some motor vehicle Bluetooth transceivers are directly coupled or built into the motor vehicle's audio entertainment system, while others are aftermarket Bluetooth transceivers that selectively mounted onto a visor located over the driver or built into a GPS navigation and traffic device mounted on the dashboard.

Bluetooth transceivers in two devices must be linked to ‘paired’ to communicate. When paired, a piconet is created between them that remains activate so long as the transceivers are activated and operated within a transmission range (typically 30 feet). Once paired, the two transceivers will automatically reconnect when activated and moved within the transmission range. Today, most drivers will ‘pair’ their cellular telephones to the motor vehicle's Bluetooth transceiver so each time the driver enters the motor vehicle with their cellular telephones, the transceivers are automatically linked.

Most Bluetooth transceivers allow the pairing information for multiple cellular telephones to be stored in memory. When a cellular telephone previously paired with the motor vehicle's Bluetooth transceiver is in the vicinity of the motor vehicle's Bluetooth transceiver, the cellular telephone will be automatically paired to the motor vehicle's Bluetooth transceiver. If two cellular telephones are simultaneously brought in the vicinity of the motor vehicle's Bluetooth transceiver, the first or most recently connected cellular telephone will reconnect to the motor vehicle Bluetooth transceiver. If a cellular telephone is connected to the motor vehicle's Bluetooth transceiver and another cellular telephone previously paired to the motor vehicle's Bluetooth transceiver is brought in the vicinity, the first cellular telephone will remain connected to the motor vehicle's Bluetooth transceiver unless the cellular telephone is inactivated or the connection is manually broken.

What is needed is a system and method that automatically determines the identity of the driver and then adjusts the entertainment settings, the seat settings, the mirror settings, and the climate control settings pre-assigned by the driver. What is also needed is a system that after identifying the driver, then provides a greeting and command voice to the driver or passenger.

### SUMMARY OF THE INVENTION

A system and method for automatically determining the identify of a previously identified driver and then automatically adjusting a vehicle's entertainment settings, the seating settings, the mirror settings, and the climate control settings desired by the driver. The system may also select and transmit customized welcome and personal voice commands to the driver while the vehicle is operated. The system includes a first Bluetooth transceiver located inside the vehicle configured to create a piconet with a compatible second Bluetooth receiver in an electronic device associated to the driver and in the motor vehicle. The first Bluetooth transceiver is coupled to control unit with a control program. The control unit is coupled to a user database, a setting database, and a voice software program. When the electronic device in the vicinity of the vehicle and a piconet is created, the identity of the driver is determined and the control unit adjusts and vehicle's the settings and the play back voice accordingly.

More specifically, the system includes a first Bluetooth transceiver located inside a motor vehicle configured to create a Bluetooth piconet with a second Bluetooth transmitter in an electronic device carried with the driver. The electronic device may be a cellular telephone, a MP3 player, a tablet computer or a laptop computer, or a motor vehicle configured key fob with smart key capabilities. Upon entering the motor vehicle, a link with motor vehicle's first Bluetooth transceiver, called a piconet, is automatically established with the second Bluetooth transceiver in the electronic device.

The system also includes a control unit located inside the motor vehicle and linked to the first Bluetooth transceiver. The control unit includes control software program loaded into its working member. The control software program is linked to various operational, entertainment, climate control, seating and mirror systems in the motor vehicle. The control software program is used to determine and record the current state of each setting or allow the user to adjust a setting at a time or a operational status of the motor vehicle. The control unit is coupled to a user database that creates a user account and then associates the user with a electronic device paired to the first Bluetooth transceiver. The selected operational, entertainment, climate control, seating and mirror systems are then associated with a user and stored in the user's database.

When the electronic device in the vicinity of the motor vehicle and a piconet is created, the identity of the driver is determined and the control unit then automatically adjusts all or some vehicle's entertainment, seating settings, climate control settings, and mirror settings according to the settings in the user database. In one embodiment, the control unit includes a voice control software program that gives audible greetings, suggestions, commands or miscellaneous information to the driver. During setup, the control unit provides a menu that that enables the drivers to select personalized male or female voices.

Sometimes, the control unit also presents a menu page that includes a youth, adult or elder mode settings with preset operational, entertainment, climate control, and mirror settings optimized for the individual. Sometimes the menu page linked to a security codes that prevents the settings from be changed.

### DESCRIPTION OF THE DRAWINGS

FIG. 1 is an illustration showing a motor vehicle with a first Bluetooth transceiver with two individuals each carrying an electronic device with a second Bluetooth transceiver configured to be paired together.

FIG. 2 is an illustration of a display in which the name of the driver or user is imputed into the system.

FIG. 3 is an illustration of a display in which youth, adult or elder mode buttons are presented that are associated with pre-programmed system settings and an optional secure code input box.

FIG. 4 is a voice menu page in which the language and gender of the playback voice used with the system is selected.

FIG. 5 is a driver designation menu page acknowledging that two previously paired second Bluetooth transceivers have been detected that are associated with different drivers and that one driver may be selected.

### DESCRIPTION OF THE PREFERRED EMBODIMENT(S)

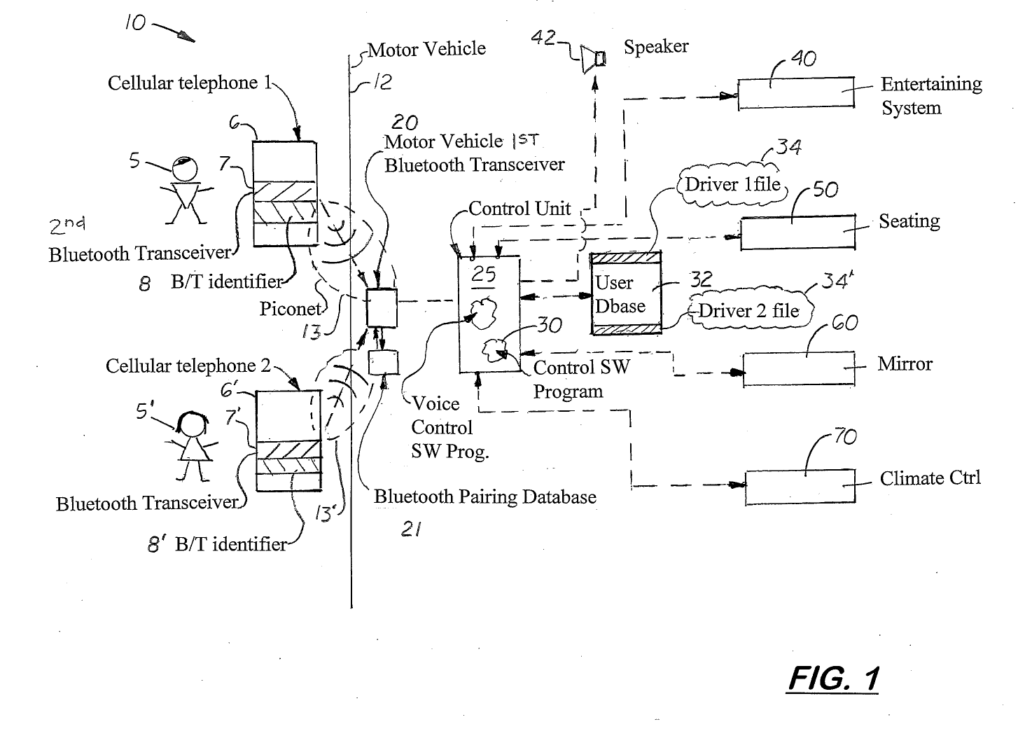

Referring to the accompanying FIG. 1, there is shown a system 10 for automatically determining the identify of a previously identified driver 5, 5′ and then automatically adjusting the motor vehicle's entertainment system 40, the seating system 50, mirror system 60 and climate control system 60 desired by the driver 5 or 5′.

The system 10 includes a motor vehicle 12 with a first Bluetooth transceiver 20 located coupled to control unit 25 with a control program 30. The control unit 25 is coupled to a user database 32, a setting database 34, and a voice software program 36. When the electronic device 6, 6′ with a second Bluetooth transceiver 7, 7′ compatible with the first Bluetooth transceiver 20 is operating in the vicinity of the motor vehicle 12, a piconet 13, 13′ is created. If the second Bluetooth transceivers 7, 7′ have already been paired to the first Bluetooth transceiver 20, the identity of the owner 5, 5′ of the electronic device 6, 6′ is assumed to be the driver 5 or 5′ and the control unit 25 then adjusts and motor vehicle's systems 40, 50, 60, or 70 to the driver's desired settings in the driver file.

In the embodiment shown, the control unit 25 is located inside the motor vehicle 12 and linked to the first Bluetooth transceiver 20. The control unit 25 includes control software program 30 loaded into its working member. The control software program 30 is linked to various operational, entertainment, climate control, seating and mirror systems 40, 50, 60, and 70. The control software program 30 is used to determine and record the current state of each system or allow the user to adjust a system setting at a time or a operational status of the motor vehicle 12. The settings of the systems 40, 50, 60, and 70 are then saved in a setting database. The control unit 25 is also coupled to a user database 32 that creates a driver file in which the electronic device, the driver's name and setting information is stored.

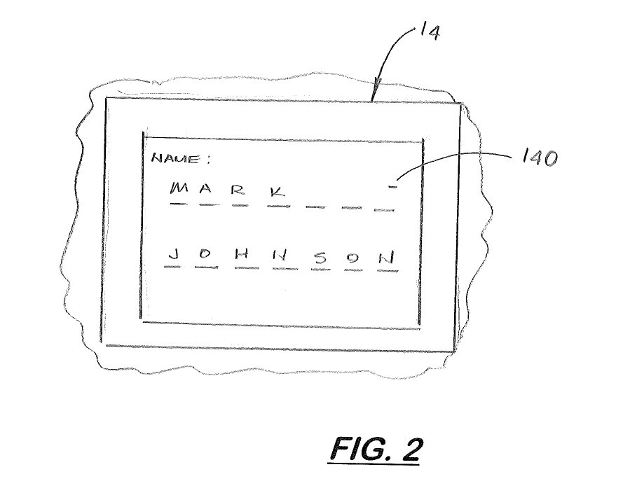

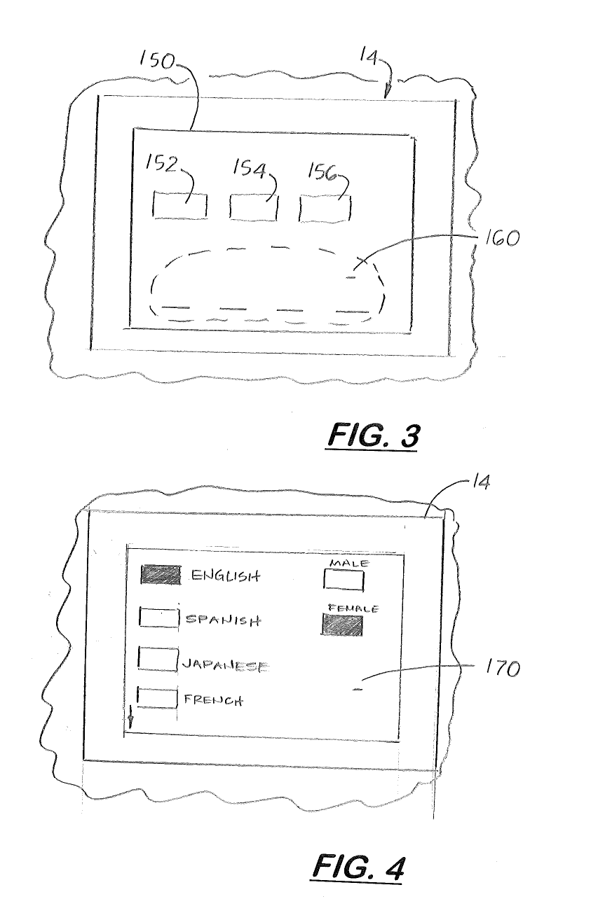

The system 10 may also be used to select and transmit or playback customized welcome and personal voice status information, and other commands to the driver 5 uponh entry or while operating the motor vehicle 12. Sometimes, the system 12 will acknowledge other individuals in the motor vehicle who may not be driving. FIG. 2 is an illustration of a display in the motor vehicle 12 in which the name of the owner of the electronic device 6, 6′ is manually imputed into the system 10. Sometimes, the control unit 30 also presents a menu page 150 shown in FIG. 3 that includes a youth, adult or elder mode buttons 152, 154, 156 settings with preset operational, entertainment, climate control, and mirror settings optimized for the individual. Sometimes the menu page 150 linked to a security code 160 that prevent the system settings from being disassociated from the user or from being changed.

FIG. 4 is a voice menu page in which the language and gender of the playback voice is selected.

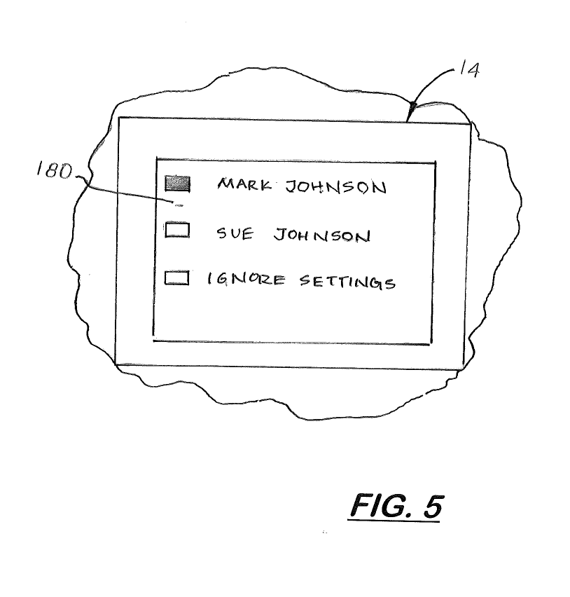

During use, the system 10 may recognize two previously paired electronic devices operating in the vicinity of the motor vehicle. For example, if both spouses enter a motor vehicle in which the cellular telephone of each spouse has been previously linked to the first Bluetooth transceiver, the system 10 will acknowledge both electronic devices have been in the vicinity and request that one of the spouse be selected as the driver. The system 10 may then automatically adjust the systems to the driver's driver file, present a second menu page FIG. 5 instructing the system 10 to use the pair non-driver settings, or ignore the system settings altogether.

I claim:

1. A system to automatically determine the identity of driver and automatically adjust a motor vehicle's settings, comprising,
a. a motor vehicle with a first Bluetooth transceiver, said first Bluetooth transceiver configured to be selectively paired with second Bluetooth transceivers in electronic device operating in the vicinity of said motor vehicle
b. an electronic device with a second Bluetooth transceiver and assigned to a driver of said motor vehicle;
c. a control unit operating in said motor vehicle, said control unit having working memory;
d. a control software program loaded into said working memory of said control unit, said control software program presents a menu page containing operational, entertainment, climate control and mirror settings; and,
e. user database coupled to said control unit, said user database containing driver information and operational, entertainment, climate control setting information selected by a user.

2. The system as recited in claim 1, further including said control software program presents a voice gender selection button.

3. The system as recited in claim 3, wherein said voice library database contains standardized or personalized greetings for each said user.

4. The system as recited in claim 1, further including a driver designation menu page on a display inside said motor vehicle acknowledging the detection of two or more previously paired second Bluetooth transceivers and allowing a driver associated with one of said second Bluetooth transceivers to be selected to control the settings of said motor vehicle.
